(19) United States
(12) Patent Application Publication
(10) Pub. No.: US 2023/0204065 A1
(43) Pub. Date: Jun. 29, 2023

(54) FASTENERS

(71) Applicant: Hatchmed Corporation, SEATTLE, WA (US)

(72) Inventor: Brian Hatch, Shoreline, WA (US)

(21) Appl. No.: 18/078,576

(22) Filed: Dec. 9, 2022

Related U.S. Application Data
(60) Provisional application No. 63/293,463, filed on Dec. 23, 2021.

(51) Int. Cl. F16B 37/14

(52) U.S. Cl. CPC F16B 37/14

(57) ABSTRACT

A fastener can be used to connect components. For example, components in a health care environment. The fastener can include a shank and a head. The head can include a driving recess that can receive a tool. An insert can be positioned in the driving recess to reduce or prevent debris from entering the driving recess.

### CROSS-REFERENCES TO RELATED APPLICATION(S)

This application is related to and claims the benefit of priority to U.S. Provisional Patent No. 63/293,463, filed Dec. 23, 2021 entitled “FASTENERS,” the contents of which is herein incorporated by reference.

### BACKGROUND OF THE INVENTION

Fasteners (e.g., screws and bolts) can be used in a variety of devices. In certain environments, for example sterile environments, bacteria and contaminants can become trapped in fasteners and openings where fasteners are inserted. Cleaning these fasteners and openings can be difficult because the openings and fasteners can be small and located in hard to reach places.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments herein are directed to fasteners. In various embodiments, the fasteners can include inserts positioned in driving recesses. In some embodiments, a retaining device can be positioned in the driving recesses, for example, to maintain the top of the insert flush with the top of the fasteners. In further embodiments, the fasteners can include a cover. The cover can be positioned on the head of the fastener. For example, the cover can be positioned on the head of the fastener such that when the fasteners is positioned in a recessed opening the top of the cover can be flush with the top of the opening.

In embodiments, a system can include first and second portions. The system can also include a fastener coupled with the first and second portions and configured to secure the first and second portions to one another, the fastener can include: a shank having first and second ends; a head coupled with the first end of the shank, the head defining a driving recess; and an insert including compressible material and being positioned within the driving recess such that an upper surface of the insert is coplanar with an upper surface of the head.

In additional embodiments, a fastener can include a shank having first and second ends. The fastener can also include a head coupled with the first end of the shank, the head defining a driving recess configured to receive a tool. The fastener can further include an insert positioned within the driving recess and including compressible material and a resistance device positioned in the driving recess between a bottom of the driving recess and the insert, the resistance device configured to resist movement of the insert when a force is applied to the insert.

In further embodiments, the fastener can include a shank having first and second ends. The fastener can also include a head coupled with the first end of the shank, the head defining a driving recess configured to receive a tool. The fastener can further include a cover positioned on the head, a portion of the cover positionable the driving recess.

### BRIEF DESCRIPTION OF THE DRAWINGS

Various embodiments in accordance with the present disclosure will be described with reference to the drawings, in which:

FIG. 1 illustrates an exploded view of an example fastener with a driving recess and an insert, according to various embodiments;

FIG. 2 illustrates an exploded view of another example fastener with a driving recess and a cap, according to various embodiments;

FIG. 3A through 4B illustrates cross-sectional views of the fastener of FIG. 1 connecting components, according to various embodiments;

FIGS. 5A through 6B illustrate cross-sectional views of the fastener of FIG. 2 connecting components, according to various embodiments;

FIG. 7 illustrates an exploded view of the fastener of FIG. 1 including a spanner driving recess and inserts, according to various embodiments;

FIG. 8 illustrates an exploded view of the fastener of FIG. 3 including resistance devices, according to various embodiments;

FIG. 9 illustrates an exploded view of the fastener of FIG. 1 including a phillips driving recess and insert, according to various embodiments;

FIG. 10 illustrates an exploded view of the fastener of FIG. 5 including a resistance device, according to various embodiments;

FIG. 11 illustrates an exploded view of the fastener of FIG. 2 including a spanner driving recess, according to various embodiments;

FIG. 12 illustrates an exploded view of the fastener of FIG. 7 including a resistance device, according to various embodiments;

FIG. 13 illustrates an exploded view of the fastener of FIG. 2 including a phillips driving recess, according to various embodiments;

FIG. 14 illustrates an exploded view of the fastener of FIG. 9 including a resistance device, according to various embodiments; and

FIG. 15 illustrates an example healthcare environment where the example fastener of FIG. 1 can be used, according to various embodiments.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Examples herein are directed to among other things, systems and techniques relating to a fastener. The techniques described herein may be implemented by any suitable fastener, but particular examples are described that can include fasteners with a shank connected to a head that includes a driving recess. The fastener can be used to join or secure components in various environments. For example, fasteners described herein can be used to join or secure components in a health care facility.

Turning now to a particular example, in this example the fastener can include a shank connected to a head that includes a driving recess. An insert can be positioned in the driving recess, for example, to prevent fluids and/or contaminants from entering the driving recess. The inserts can include flexible (e.g., compressible) material that allows the inserts to be compressed. The inserts can be compressed, for example, using a tool. Compressing the inserts can allow the tool to loosen and/or tighten the fastener. In various embodiments, the fasteners can include a resistance device can be positioned in the driving recess (e.g., between the bottom of the driving recess and the inserts). The resistance device can bias the inserts toward the top of the driving recess (e.g., to seal the driving recess). For example, the resistance device can bias the inserts such that a top of the inserts is generally coplanar with the top of the driving recess. The resistance device can bias the inserts such that after the inserts are moved into the driving recess (e.g., by a tool) the resistance device causes the inserts to move back to a position to seal the driving recess.

Turning now to another example, in this example a fastener can include a shank connected to a head that includes a driving recess. A cap can be positioned on top of the head (e.g., positioned on top of the head and covering the driving recess). The cap can seal an opening that a fastener is inserted into. For example, the head of the fastener can be positioned in an opening below an edge of a component and the cap can extend above the fastener to the edge of the component. The cap can include material that can allow a tool to be inserted into the driving recess. For example, a portion of the cap can be moved into the driving recess to allow the tool to be positioned in the driving recess to allow the tool to tighten and/or loosen the fastener. In some embodiments, the cap can be larger than the head (e.g., the cap can extend beyond the edges of the head). For example, the cap can include a skirt that can form a seal around a fastener opening. In various embodiments, a resistance device can be positioned in the driving recess (e.g., between the bottom of the driving recess and the bottom of the cap). The resistance device can bias the cap such that the cap returns to a starting state after the tool has been removed.

Turning now to the figures, FIG. 1 illustrates an exploded view of an example fastener 100 with a driving recess 102 and an insert 104. The fastener 100 can be used to connect components in various environments. For example, the fastener 100 can be used to connect components in a health care environment (e.g., a hospital, a nursing home, or a health care facility). The fastener 100 can additionally or alternatively be used in a clean room environment, a surgical environment, a cooking environment, and/or any suitable environment where surfaces need to be cleaned routinely. The fastener 100 can include a shank 106 connected to a head 108. In various embodiments, one end of the shank 106 can include threads 110. The threads 110 can engage with one or more of the components. For example, the threads 110 can engage with threads of one of the components. The fastener 100 (e.g., the head 108 and/or the shank 106) can be or include metal (e.g., aluminum or stainless steel), plastic, or any suitable strong material. In some embodiments, the fastener 100 can be or include material that can be used in a health care facility (e.g., material that can be easily wiped and/or cleaned).

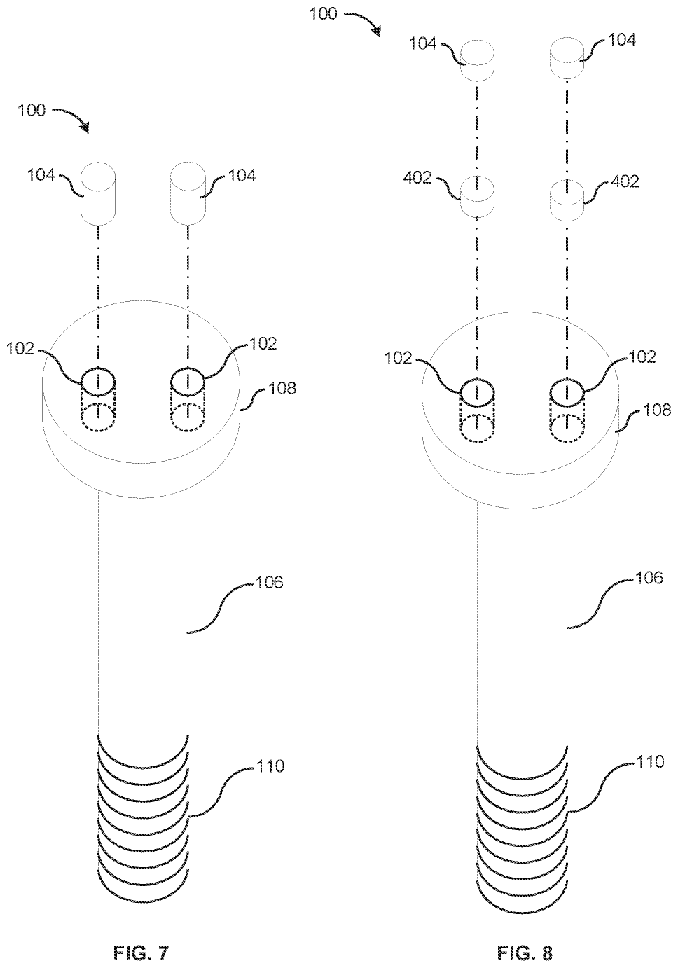

The head 108 can include a driving recess 102. The driving recess 102 can be sized and/or shaped to receive a tool. For example, driving recess 102 can receive a tool that can be used to install the fastener 100 (e.g., to join the components together). In various embodiments, the driving recess 102 can have one or more of a slotted shape, a frearson shape, a tori shape, a phillips shape, a hex shape, a square shape, a spanner shape, or a clutch shape. For example, FIGS. 7, 8, 11, and 12 include a spanner shaped driving recess 102 and FIGS. 9, 10, 13, and 14 include a phillips shaped driving recess 102.

In traditional fasteners, the driving recess 102 is open to the environment (e.g., to allow the tool to be inserted into the driving recess 102). However, the driving recess 102 being exposed to the environment can allow debris and/or contaminants to enter the driving recess 102. In clean environments, (e.g., hospitals and/or healthcare facilities) the driving recess 102 can harbor contaminants and/or debris which can cause illness. The driving recess 102 can be cleaned (e.g., using a cleaning product), however, some fasteners 100 may be positioned where cleaning is very difficult and/or where the driving recess 102 may not be able to be completely cleaned.

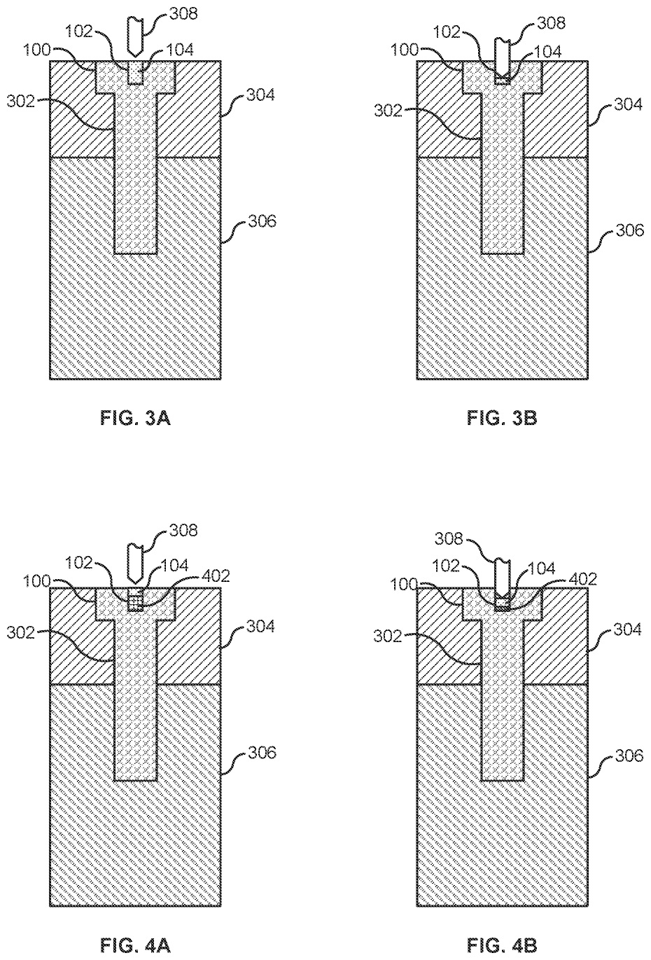

In various embodiments, the insert 104 can be or include compressible material. For example, the compressible material can be one material or a combination of multiple materials that each is compressible on its own (e.g., rubber, silicon, silicone, or any suitable compressible material) and/or a combination of an element with a compression mechanism (e.g., a combination of a rigid or non-rigid material, such as a rigid plastic, metal, or rubber, that is spring loaded) such that the insert 104 can be compressed into the driving recess 102, for example, using a tool (e.g., as shown in FIGS. 3A and 3B). In further embodiments, the insert 104 can be or include rigid or semi-rigid material (e.g., plastic, metal, carbon fiber, or any suitable rigid or semi-rigid material), possibly with a combination of a compressible mechanism (e.g., a spring) such that the insert 104 can be moved into the driving recess 102.

In various embodiments, the insert 104 can be or include compressible material. For example, the compressible material can be one material or a combination of multiple materials that each is compressible on its own (e.g., rubber, silicon, silicone, or any suitable compressible material) and/or a combination of an element with a compression mechanism (e.g., a combination of a rigid or non-rigid material, such as a rigid plastic, metal, or rubber, that is spring loaded) such that the insert 104 can be compressed into the driving recess 102, for example, using a tool (e.g., as shown in FIGS. 3A and 3B). In further embodiments, the insert 104 can be or include rigid or semi-rigid material (e.g., plastic, metal, carbon fiber, or any suitable rigid or semi-rigid material), possibly with a combination of a compressible mechanism (e.g., a spring) such that the insert 104 can be moved into the driving recess 102.

In further embodiments, the fastener 100 can include a resistance device (e.g., as shown in FIGS. 4A and 4B). The resistance device can be positioned in the driving recess 102 (e.g., between the bottom of the driving recess 102 and the insert 104). The resistance device can bias the insert 104 such that the top of the insert 104 is generally aligned with the top of the head 108. The resistance device can resist a force applied to the insert 104 (e.g., by a tool). The force can cause the insert 104 to move into the driving recess 102. The resistance device can return the insert 104 to a starting position after the force has been removed (e.g., after the tool has been removed). The resistance device can be or include a spring, one or more magnets, a compressible material, and/or any suitable device for biasing the insert 104.

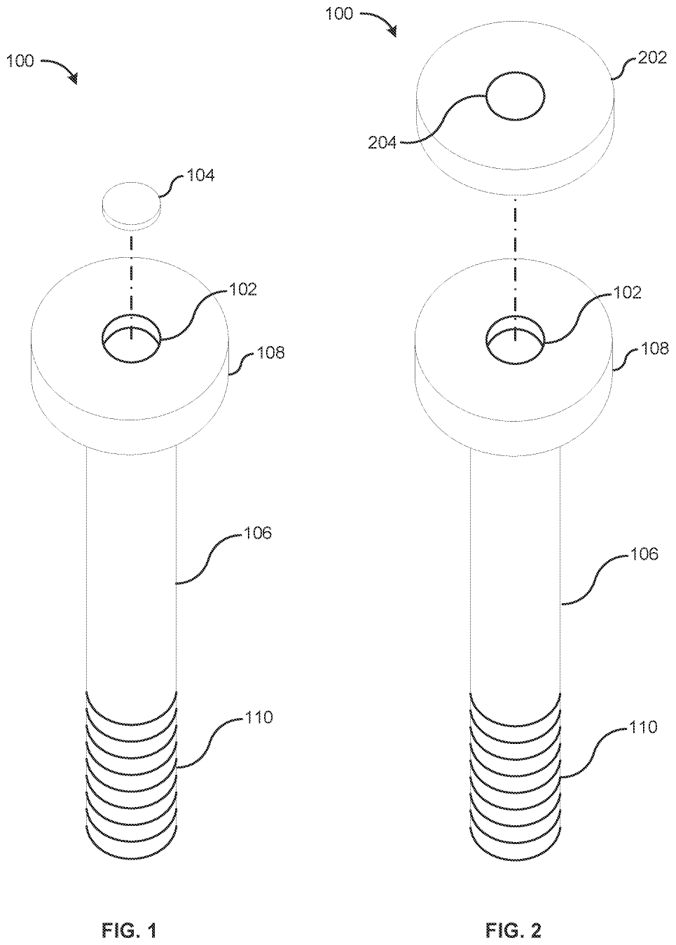

Turning to FIG. 2, another example fastener 100 is shown. The fastener 100 can include a cover 202. The cover 202 can be positioned on an upper surface of the head 108. For example, the cover 202 can cover the driving recess 102. The cover 202 can be or include compressible material (e.g., rubber, silicone, silicon, and/or any suitable compressible material). However, the cover 202 can be or include rigid or semi-rigid material (e.g., plastic, metal, carbon fiber, and/or any suitable rigid or semi-rigid material).

The compressible material can allow a portion of the cover 202 to flex. The cover 202 can flex to allow a tool to be positioned in the driving recess 102. For example, a tool can be pressed against the cover 202 to cause the cover 202 to flex and the tool to be inserted in the driving recess 102. The tool can then be used to loosen and/or tighten the fastener 100. When the tool is removed, the cover 202 can return to a relaxed position (e.g., a starting position). The cover 202 can be compressed multiple times to allow the tool to be used to tighten or loosen the fastener multiple times. In some embodiments, a resistance device can be used to return the cover 202 to a starting position. For example, a resistance device can be positioned in the driving recess 102 and used to return the cover 202 to the starting position.

In various embodiments, a portion of the cover 202 can be moveable relative to the rest of the cover 202. For example, a portion of the cover 202 can be moveable into the driving recess 102. The portion of the cover 202 can be moved into the driving recess 102 using a tool. A resistance device can be positioned in the driving recess 102. The resistance device can bias the portion of the cover 202 into a starting position. For example, the resistance device can allow the portion of the cover 202 to be depressed and return the cover 202 to a starting position. In various embodiments, the portion of the cover 202 can be or include compressible material such that the cover 202 can be compressed into the driving recess 102. Additionally or alternatively, the portion of the cover 202 can be or include rigid or semi-rigid material.

The cover 202 can have a cross-section that is generally the same size and shape as the cross-section of the head 108 (e.g., as shown in FIGS. 6A and 6B). For example, if the head 108 has an elliptical cross-section with a diameter, the cover 202 can have an elliptical cross-section with a diameter that is generally the same size as the diameter of the head 108.

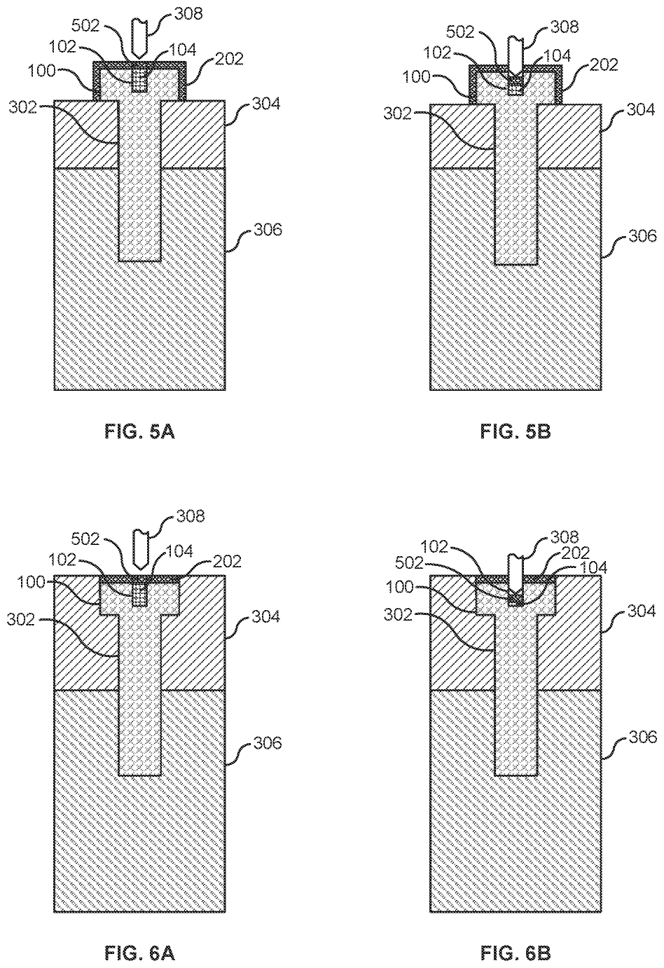

In various embodiments, the cover 202 can be larger than the head 108. For example, as shown in FIGS. 5A and 5B, the cover 202 can extend around the sides of the head 108. The cover 202 can extend around the sides of the head 108 and create a seal between the sides of the head 108 and a component. Additionally or alternatively, the cover 202 can have a portion that can be used to prevent or reduce contaminants and/or debris from entering a fastener opening. For example, an upper portion of the cover 202 can include a ski extends beyond the edges of the head 108.

In some embodiments, the cover 202 can include markings 204. The markings 204 can be positioned on the cover 202 such that a tool can be aligned with the driving recess 102. For example, the markings 204 can be positioned above the location of the driving recess 102 such that a user can align the tool with the markings and apply a force to move the tool into the driving recess 102 (e.g., by flexing, compressing, and/or moving a portion of the cover 202). Additionally or alternatively the markings 204 can be the same shape as the driving recess 102. For example, the driving recess can be a phillips shaped driving recess 102 and the markings 204 can have a phillips shape.

Turning to FIGS. 3A through 4B, cross-sectional views of a fastener 100 inserted into an opening 302 to connect components 304 and 306 is shown. The fastener 100 can include an insert 104 positioned in a driving recess 102. The insert 104 positioned in the driving recess 102 can prevent or reduce debris and/or contaminants from entering the driving recess 102. As shown in FIG. 3A, the insert 104 can create a generally flat surface (e.g., along the upper surface of component 304) that can be wiped and/or cleaned. The driving recess 102 and/or the insert 104 can be sized and shaped to receive a tool 308 that can be used to loosen and/or tighten the fastener 100.

As shown in FIG. 3B, the tool 308 can be inserted into the driving recess 102 and compress the insert 104. The insert 104 can be compressed to allow the tool 308 to be positioned in the driving recess 102 such that the tool 308 cool be used to loosen and/or tighten the fastener 100. When the tool 308 is removed from the driving recess 102 (e.g., after the fastener 100 has been tightened and/or loosened) the insert 104 can return to an uncompressed state (e.g., as shown in FIG. 3A). The insert 104 can be or include material that can be repeatedly compressed and uncompressed numerous times. For example, the insert 104 can be or include material that can be compressed and return to an uncompressed state such that the fastener 100 can be loosened and/or tightened multiple times.

As shown in FIG. 4A and 4B, the fastener 100 can include a resistance device 402 positioned in the driving recess 102 between the bottom of the driving recess 102 and an insert 104. As shown in FIG. 4A the resistance device 402 can bias the insert 104 such that the top of the insert 104 is generally aligned (e.g., generally co-planar) with the top of the fastener 100 and/or the top of the component 304. The resistance device 402 can be or include a spring. The spring can be connected to the bottom of the driving recess 102 and the insert 104. The resistance device 402 can additionally or alternatively include magnets (e.g., opposing magnets). For example, a magnet can be positioned at the bottom of the driving recess 102 and another opposing magnet can be attached to the insert 104.

As shown in FIG. 4B, a tool 308 can be inserted into the driving recess 102. The tool 308 can apply a force to the insert 104 and/or the resistance device 402. The force can cause the resistance device 402 to move and/or compress. The movement and/or compression of the resistance device 402 can allow the tool 308 to be positioned in the driving recess 102. The tool 308 can then be used to loosen and/or tighten the fastener 100. After the force has been removed (e.g., the tool 308 has been removed) the resistance device 402 can cause the insert 104 to move back to a starting position (e.g., the position shown in FIG. 4A). In some embodiments, the insert 104 can be or include rigid or semi-rigid material. The rigid or semi-rigid material can allow the insert 104 to move along the driving recess 102. However, the insert 104 can be or include compressible material.

Turning to FIGS. 5A through 6B, cross-sectional views of a fastener 100 with a cover 202 inserted into an opening 302 to connect components 304 and 306 is shown. The cover 202 can be positioned on an upper surface of the fastener 100 (e.g., on an upper surface of the head 108). The cover 202 can extend beyond the edges of the upper surface of the head 108 and down the sides of the head 108. The cover 202 can extend down the sides of the head 108 and engage with the top of the component 304. The cover 202 can reduce or prevent debris and contaminants from entering the driving recess 102 (e.g., by covering the driving recess 102). Additionally or alternatively, the cover 202 can reduce debris and contaminants from getting between the bottom of the head 108 and the top of the component 304.

In various embodiments, the fastener 100 can include a resistance device 402. The resistance device 402 can bias the cover 202 (e.g., prevent the cover 202 from sagging into the driving recess 102) and/or can move the cover 202 back to a starting position. As shown in FIG. 5A the cover 202 can have a relaxed position (e.g., a starting position) where the cover 202 extends over the driving recess 102 As shown in FIG. 5B, a tool 308 can be used to move a portion of the cover 202 (e.g., portion 502) into the driving recess 102. For example, the tool 308 can cause the portion 502 to compress, flex, and/or move into the driving recess 102. The portion of the cover 202 can be moved into the driving recess 102 to allow a portion of the tool 308 to be positioned in the driving recess 102. The tool 308 can then be used to tighten and/or loosen the fastener 100. The resistance device 402 can move the portion 502 back to the starting position.

As shown in FIGS. 6A and 6B, the fastener 100 can be inserted into an opening 302 and the cover 202 can reduce or prevent debris and contaminants from entering the opening 302 (e.g., by sealing the opening 302). For example, the cover 202 can have a thickness such that the upper surface of the cover 202 is generally aligned (e.g., generally coplanar) with the upper surface of component 304.

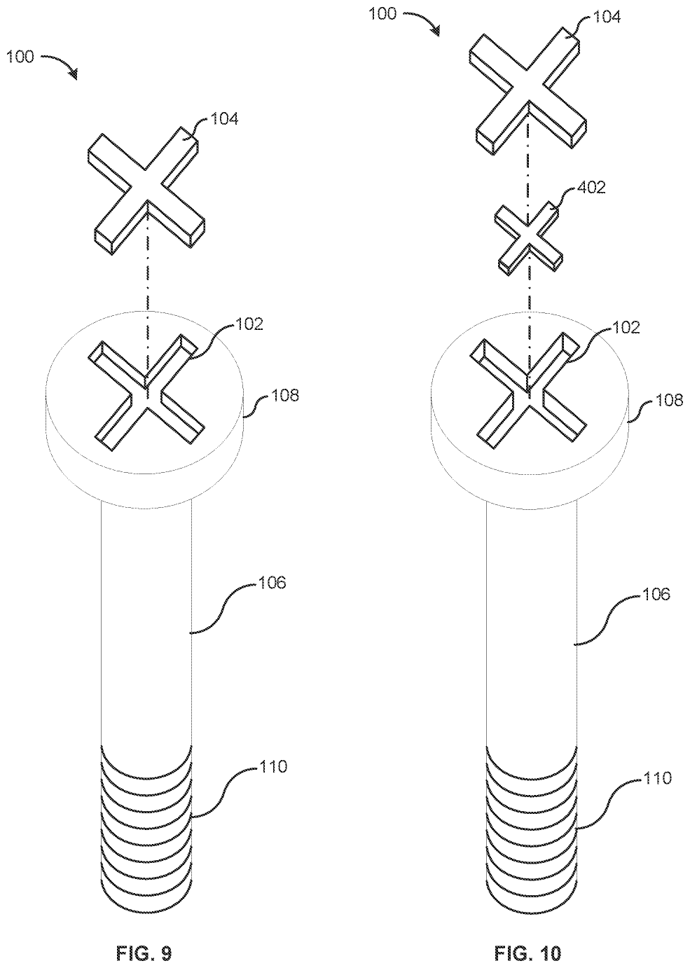

Turning to FIGS. 7 through 14, example fasteners 100 are shown. FIGS. 7 and 8 show fasteners 100 with a driving recess 102 that is a spanner shape. For example, the driving recess 102 can include two driving recesses 102. Each driving recess can receive an insert 104 (e.g., as shown in FIG. 7) and/or an insert 104 and a resistance device 402 (e.g., as shown in FIG. 8). The insert 104 and/or the resistance device 402 can be sized and shaped to fit in the driving recess 102. For example, the insert 104 can be cylindrical and can have a height that is substantially the same as the height of the driving recess 102. Additionally or alternatively the resistance device 402 can have a cylindrical shape. The resistance device 402 and the insert 104 can have a combined height that is substantially the same as the height of the driving recess 102. However, the insert 104 and/or the resistance device 402 can have any suitable size and shape.

FIGS. 9 and 10 show fasteners 100 with a driving recess 102 that is a phillips shaped driving recess 102 (e.g., a cross). The insert 104 can have the same or a substantially similar size and shape to tit in the phillips shaped driving recess 102. As shown in FIG. 10, a resistance device 402 can be positioned in the driving recess 102 (e.g., between the bottom of the driving recess 102 and the insert 104). The resistance device 402 can have the same shape as the driving recess 102 (e.g., the resistance device 402 can have a phillips shape). However, the resistance device 402 can have a different shape than the driving recess 102. The resistance device 402 can be substantially the same size as the driving recess 102 (e.g., with the same or similar dimensions). However, the resistance device 402 can be smaller than driving recess 102. For example, the resistance device 402 can be smaller than the driving recess 102 such that the resistance device 402 is positionable in the driving recess 102 (e.g., positioned at the center of the driving recess 102 and/or the insert 104).

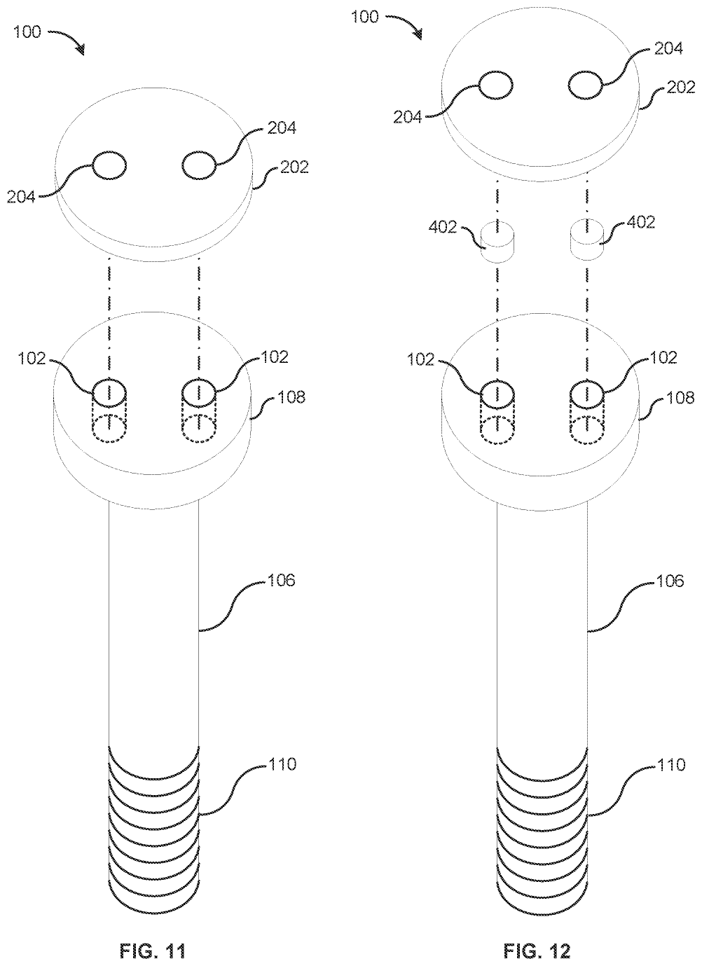

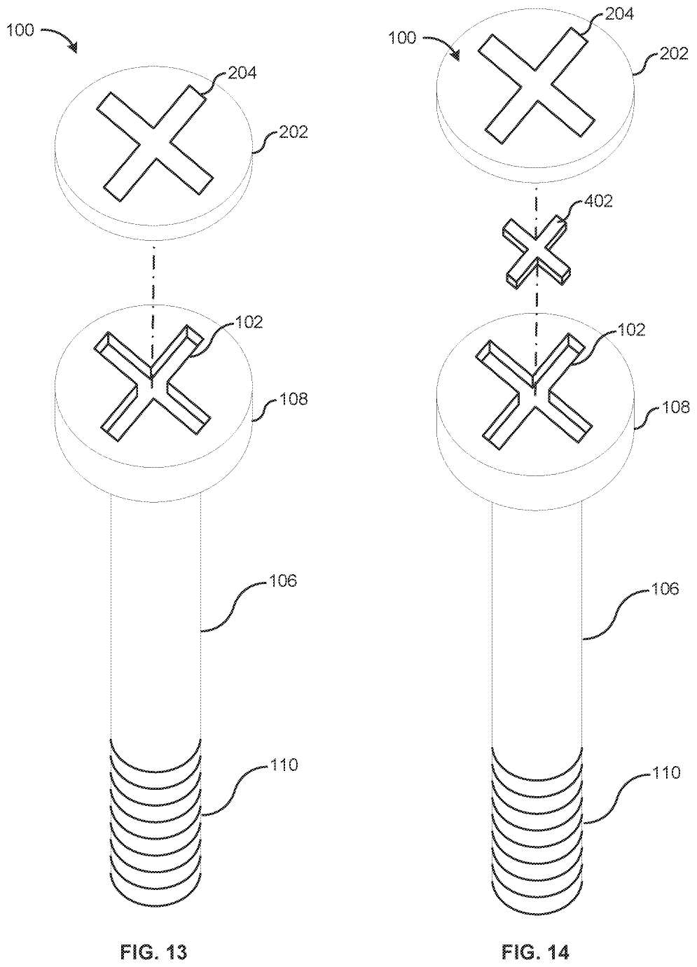

Turning to FIGS. 11 through 14, example fasteners 100 are shown that include a cover 202. FIGS. 11 and 12 show a fastener 100 that include a driving recess 102 that is spanner shaped. FIGS. 13 and 14 show a fastener 100 that include a driving recess 102 that is phillips shaped. The cover 202 can include markings 204 that align with the driving recess 102 when the cover 202 is positioned on the fastener 100 (e.g., on the head 108). As shown in FIGS. 12 and 14, a resistance device 402 can be positioned in the driving recess 102 (e.g., below the cover 202).

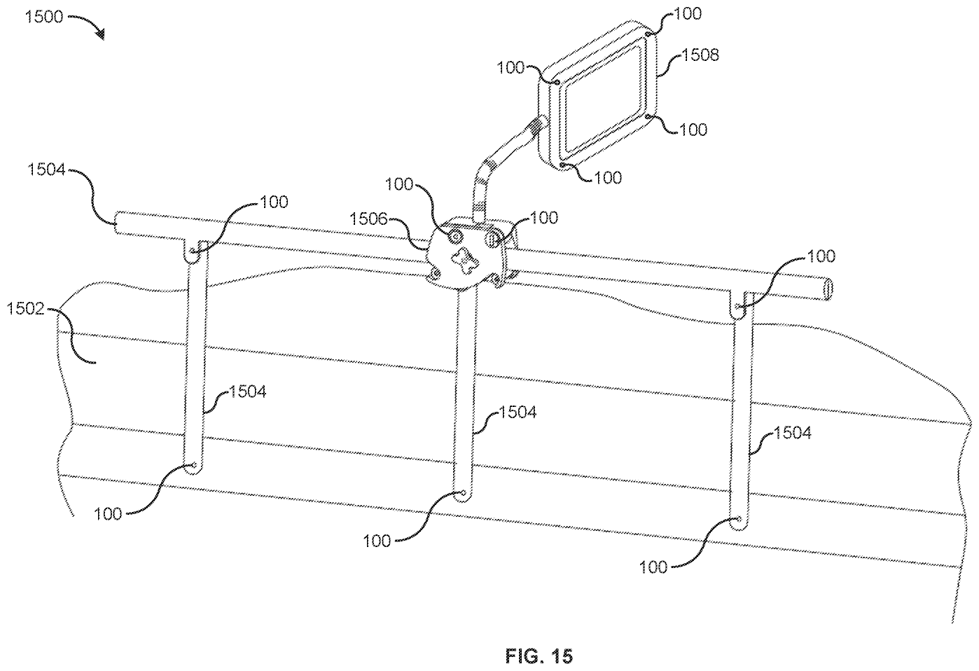

Turning to FIG. 15, an example healthcare environment 1500 where one or more fasteners 100 can be used is shown. The healthcare environment 1500 can be or include hospitals, a nursing home, assisted living facilities, clean room facilities, outpatient clinics, in home health care and/or a health care facility. The healthcare environment 1500 can include a hospital bed 1502 (e.g., a hospital stretcher). The hospital bed 1502 can be or include a patient holder specially designed for hospitalized patients or others in need of some form of health care. As used herein throughout this disclosure, a “bed” refers to any patient holder. The hospital bed 1502 can have special features both for the comfort and well-being of the patient and for the convenience of health care workers. Common features include adjustable height for the entire bed, the head, and the feet, side rails 1504 (e.g., adjustable rails), and electronic buttons to operate both the bed and other nearby electronic devices. The hospital bed 1502 and other similar types of beds are used not only in hospitals, but in other health care facilities and settings, such as nursing homes, assisted living facilities, outpatient clinics, and in home health care.

In various embodiments, the hospital bed 1502 can include one or more fasteners 100. For example, fasteners 100 can be used to attach the side rails 1504 to the hospital bed 1502. Additionally of alternatively the fasteners 100 can be used to attach the side rails 1504 to one another. In further embodiments, the fasteners 100 can be used with an attachment device 1506. For example, the fasteners 100 can be used to secure the attachment device 1506 to the side rails 1504. Additionally or alternatively, the fasteners 100 can be used to attach components of the attachment device 1506 to one another. The attachment device 1506 can be used to attach various devices to the side rails 1504. For example, the attachment device 1506 can be used to attach an electronic device 1508 to the side rails 1504. Fasteners 100 can be used in the electronic device 1508 to secure components of the electronic device 1508 to one another.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A system comprising:
first and second portions;
a fastener coupled with the first and second portions and configured to secure the first and second portions to one another, the fastener comprising:
a shank having first and second ends;
a head coupled with the first end of the shank, the head defining a driving recess; and
an insert comprising compressible material and being positioned within the driving recess such that an upper surface of the insert is coplanar with an upper surface of the head.

2. The system of claim 1, wherein the system is positioned in a health care environment.

3. The system of claim 1, wherein the insert comprises one or more of rubber, silicon, or silicone.

4. The system of claim 1, wherein the insert further comprises rigid or semi-rigid material.

5. The system of claim 1, further comprising a cover coupled with the insert and positionable on the head.

6. The system of claim 1, further comprising a resistance device positioned in the driving recess, the resistance device positioned between a bottom of the recess and the insert and configured to resist movement of the insert when a force is applied to the insert.

7. The system of claim 6, wherein the resistance device comprises a spring or a magnet.

8. The system of claim 6, wherein the force is applied to the insert with a tool, the tool having an end configured to be inserted into the driving recess.

9. The system of claim 1, wherein the driving recess has a slotted shape, a frearson shape, a torx shape, a phillips shape, a hex shape, a square shape, a spanner shape, or a clutch shape.

10. A fastener comprising:
a shank having first and second ends;
a head coupled with the first end of the shank, the head defining a driving recess configured to receive a tool;
an insert positioned within the driving recess and comprising compressible material; and
a resistance device positioned in the driving recess between a bottom of the driving recess and the insert, the resistance device configured to resist movement of the insert when a force is applied to the insert.

11. The fastener of claim 10, wherein the resistance device comprises a spring or a magnet.

12. The fastener of claim 10, further comprising a cover coupled with the insert, the cover positionable on the head.

13. The fastener of claim 12, wherein the cover and the insert comprise one or more of rubber, silicon, or silicone.

14. The fastener of claim 10, wherein the resistance device is further configured to make a top of the insert coplanar with an upper surface of the head.

15. The fastener of claim 10, wherein the driving recess comprises a slotted shape, a frearson shape, a torx shape, a phillips shape, a hex shape, a square shape, a spanner shape, or a clutch shape.

16. A fastener comprising:
a shank having first and second ends;
a head coupled with the first end of the shank, the head defining a driving recess configured to receive a tool; and
a cover positioned on the head, a portion of the cover positionable the driving recess.

17. The fastener of claim 16, wherein the cover extends to an edge of the head.

18. The fastener of claim 16, wherein the cover extends beyond an edge of the head.

19. The fastener of claim 16, further comprising a resistance device positioned in the driving, the resistance device configured to resist the portion of the cover that is positionable in the driving recess.

20. The fastener of claim 16, wherein the head comprises a mark, the mark identifying a location of the driving recess.
